(19) United States
(12) Patent Application Publication
(10) Pub. No.: US 2012/0218531 A1
(43) Pub. Date: Aug. 30, 2012

(54) DEVELOPING METHOD AND APPARATUS USING ORGANIC-SOLVENT CONTAINING DEVELOPER

(75) Inventors: Kouichi Hontake, Koshi-Shi (JP); Takafumi Niwa, Koshi-Shi (JP); Hideharu Kyouda, Koshi-Shi (JP); Kousuke Yoshihara, Koshi-Shi (JP)

(73) Assignee: Tokyo Electron Limited, Minato-Ku (JP)

(21) Appl. No.: 13/397,043

(22) Filed: Feb. 15, 2012

(30) Foreign Application Priority Data
Feb. 24, 2011 (JP) 2011-037760
Nov. 18, 2011 (JP) 2011-252571

(51) Int. Cl. G03B 27/32

(52) U.S. Cl. 355/27

(57) ABSTRACT

Provided are a developing method and a developing apparatus that can reduce process time and improve throughput in a developing process using a developer containing organic solvent. The present invention relates to a developing method for performing developing by supplying a developer containing organic solvent to a substrate having its surface coated with a resist and exposed. The developing method of the invention includes a liquid film forming step for forming a liquid film by supplying the developer from a developer supply nozzle to a central portion of the substrate while rotating the substrate, and a developing step for developing the resist film on the substrate while rotating the substrate in a state where the supply of the developer from the developer supply nozzle to the substrate is stopped and in such a manner that the liquid film of the developer would not dry.

### REFERENCE TO RELATED APPLICATION

This application claims the benefits of Japanese Patent Application No. 2011-37760 filed on Feb. 24, 2011, and of Japanese Patent Application No. 2011-252571 filed on Nov. 18, 2011, the disclosures of which are incorporated by reference herein in its entirety.

### BACKGROUND OF THE INVENTION

1. Field of the Invention

The present invention relates to a developing method and apparatus for performing developing by supplying a developer containing an organic solvent to a substrate such as a semiconductor wafer having its surface coated with a resist and exposed.

2. Description of the Related Art

In manufacturing lines for semiconductor wafers and the like, photolithography is generally used to form a resist pattern on the surface of a semiconductor wafer or LCD substrate. Photolithography is a technique in which a predetermined resist pattern is formed on the surface of a substrate by sequentially conducting a series of processes such as a resist-coating process for coating a resist solution over the surface of the substrate, exposure process for exposing the pattern on the formed resist film, and developing process in which a developer solution is supplied to the exposed substrate.

For the developing process, there are known a positive type system in which a pattern is formed by selectively dissolving and removing the portions irradiated with high light intensity among the entire area of the resist film exposed in the exposure process, and a negative type system in which a pattern is formed by selectively dissolving and removing the portions irradiated with low intensity light. In this case in the negative-type system, developing is conducted by supplying the substrate a developer containing organic solvent.

As a method for supplying a developer containing organic solvent to the substrate in the negative-type system, a method is known in which the developer is continuously jetted from a developer discharge nozzle to the substrate rotating at a fixed speed while the developer discharge nozzle scans the substrate. Such method is, for example, described in JP-A-2010-152353.
Document 1:JP-A-2010-152353

### SUMMARY OF THE INVENTION

However, in the developing method described in JP-A-2010-152353, since the developer discharge nozzle continuously jets out the developer to the substrate spinning at a fixed speed, the liquid film of the developer formed over the surface of the substrate becomes thick. When the liquid film of the developer containing organic solvent is thick, decrease in the dissolution/removal speed of the resist film may prolong the process time of developing.

The present invention has been made with consideration of the above circumstances. An object of the present invention is to provide a developing method and developing apparatus that can reduce process time and improve throughput in a developing process using a developer containing organic solvent.

In order to solve the foregoing problem, an aspect of the present invention provides a developing method for performing developing by supplying a developer containing an organic solvent to a substrate having its surface coated with a resist and exposed, the developing method comprising the steps of: a liquid film forming step for forming a liquid film by supplying the developer from a developer supply nozzle to a central portion of the substrate while rotating the substrate; and a developing step for developing the resist film on the substrate while rotating the substrate in a state where the supply of the developer from the developer supply nozzle to the substrate is stopped and in such a manner that the liquid film of the developer would not dry.

Preferably, in the liquid film forming step, the substrate rotates at a first speed; in the developing step, the substrate rotates at a speed lower than the first speed that does not accelerate the drying of the liquid film of the developer; and the developing method further comprises a cleaning step for washing away the existing developer containing the resist components dissolved therein in the developing step by supplying the developer from the developer supply nozzle to the central portion of the substrate while rotating the substrate at a third speed higher than the second speed.

Preferably, the first rotating speed is between 100 rpm and 1,500 rpm, and the second rotating speed is between 10 rpm and 100 rpm.

Preferably, the liquid film forming step and the developing step are alternatively repeated for a plurality of times.

Preferably, the developing method further comprises, before the liquid film forming step in which the developer is supplied from the developer supply nozzle to the central portion of the substrate, a step of continuously supplying the developer from the developer supply nozzle to the substrate while rotating the substrate and moving the nozzle from a circumferential portion of the substrate to the central portion thereof.

Preferably, after the liquid film forming step in which the developer is supplied from the developer supply nozzle to the central portion of the substrate, a cleaning step in which the developer is supplied from the developer supply nozzle to the substrate while rotating the substrate and moving the nozzle from the central portion of the substrate to a circumferential portion thereof, and the developing step in which the supply of the developer from the developer supply nozzle to the substrate is stopped, are alternatively repeated for a plurality of times.

Preferably, a plurality of the developer supply nozzles are provided; in the liquid film forming step, the developer is supplied from the developer supply nozzles to the central portion of the substrate and portions thereof other than the central portion; and in the developing step, the supply of the developer from the developer supply nozzles to the substrate is stopped.

Preferably, the developing method further comprises steps subsequent to the liquid film forming step and the developing step: a step of supplying a rinsing liquid from a rinsing liquid supply nozzle to the substrate while rotating the substrate, and a step for drying the substrate by rotating the substrate after supplying the rinsing liquid from the rinsing liquid supply nozzle to the substrate.

In order to implement the developing method outlined above, another aspect of the present invention provides a developing apparatus for performing developing by supplying a developer containing an organic solvent to a substrate having its surface coated with a resist and exposed, the developing apparatus comprising: a substrate retainer for retaining the substrate horizontally; a rotation driving mechanism for rotating the substrate retainer about a vertical axis; a developer supply nozzle for supplying the developer to a surface of the substrate retained by the substrate retainer; and a controller for controlling the rotation driving mechanism and the supply of the developer from the developer supply nozzle to the substrate; wherein, in accordance with a control signal from the controller, the developing apparatus conducts a liquid film forming process and a developing process, the liquid film forming process forming a liquid film by supplying the developer from the developer supply nozzle to a central portion of the substrate while rotating the substrate, the developing process developing the resist film on the substrate while rotating the substrate in a state where the supply of the developer from the developer supply nozzle to the substrate is stopped and in such a manner that the liquid film of the developer would not dry.

Preferably, in the liquid film forming process, the substrate rotates at a first speed; in the developing process, the substrate rotates at a speed lower than the first speed that does not accelerate drying of the liquid film of the developer; the developing apparatus also performs a cleaning process for washing away the existing developer containing the resist components dissolved therein in the developing process by supplying the developer from the developer supply nozzle to the central portion of the substrate while rotating the substrate at a third speed higher than the second speed; and the speed of rotation is controlled according to a control signal from the controller.

Preferably the first rotating speed is between 100 rpm and 1,500 rpm, and the second rotating speed is between 10 rpm and 100 rpm.

Preferably the liquid film forming step in which the developer is supplied to the central portion of the substrate from the developer supply nozzle, and the developing step in which the supply of the developer is stopped, are alternatively repeated for a plurality of times in accordance with a control signal from the controller.

Preferably, the developing apparatus further comprises: a developer supply nozzle moving mechanism for moving the developer supply nozzle such that the developer supply nozzle can move in a direction along the surface of the substrate according to control of the controller. The controller may, before the liquid film forming step in which the developer is supplied from the developer supply nozzle to the central portion of the substrate, control to continuously supply the developer from the developer supply nozzle to the substrate while moving the developer supply nozzle from a circumferential portion of the substrate to the central portion thereof.

Preferably, the developing apparatus further comprises a developer supply nozzle moving mechanism for moving the developer supply nozzle such that the developer supply nozzle can move in a direction along the surface of the substrate according to control of the controller. The controller may, after the liquid film forming step in which the developer is supplied from the developer supply nozzle to the central portion of the substrate, control to alternatively repeat, for a plurality of times, a cleaning process in which the developer is supplied from the developer supply nozzle to the substrate while moving the developer supply nozzle from the central portion of the substrate to a circumferential portion thereof, and the developing process in which the supply of the developer from the developer supply nozzle to the substrate is stopped.

Preferably, a plurality of the developer supply nozzles are provided; in the liquid film forming process, the developer is supplied from the developer supply nozzles to the central portion of the substrate and portions thereof other than the central portion; and in the developing process, the supply of the developer from the developer supply nozzles to the substrate is stopped.

Preferably, the developing apparatus further comprises: a rinsing liquid supply nozzle for supplying a rinsing liquid to the substrate; and a rinsing liquid supply nozzle moving mechanism for moving the rinsing liquid supply nozzle such that the rinsing liquid supply nozzle can move in a direction along the surface of the substrate according to control of the controller. The controller may, after the liquid film forming process and the developing process, control to perform a process of supplying the rinsing liquid from the rinsing liquid supply nozzle to the substrate while rotating the substrate, and a process for drying the substrate by rotating the substrate after supplying the rinsing liquid from the rinsing liquid supply nozzle to the substrate.

In the developing method and developing apparatus according to the present invention that use the developer containing an organic solvent, the liquid film forming step for forming a liquid film by supplying the developer from a developer supply nozzle to a central portion of the substrate while rotating the substrate, and the developing step for developing the resist film on the substrate while rotating the substrate in a state where the supply of the developer from the developer supply nozzle to the substrate is stopped and in such a manner that the liquid film of the developer would not dry, are performed. Thus, the liquid film of the developer formed on the surface of the substrate can be kept thin and the resist film dissolution/removal speed can be increased. The time required for the developing process is therefore reduced, resulting in an improved throughput.

### BRIEF DESCRIPTION OF THE DRAWINGS

FIG. 1 is a schematic perspective view showing the whole of a processing system that includes a coating/developing apparatus to which a developing apparatus according to the present invention is applied and an exposure apparatus connected thereto;

FIG. 2 is a schematic plan view of the processing system;

FIG. 3 is a schematic cross-sectional view showing the developing apparatus according to the present invention;

FIG. 4 is a schematic plan view of the developing apparatus;

FIG. 5 is a flowchart showing the developing sequence of a first embodiment;

FIG. 6(a) is a schematic perspective view showing the liquid film forming step in which a developer is supplied from a developer supply nozzle to the central portion of the substrate;

FIG. 6(b) is a schematic perspective view showing the developing step in which the supply of the developer from the developer supply nozzle to the substrate is stopped;

FIG. 7 shows a relationship between pattern line width and a step of the first embodiment;

FIG. 8 shows a relationship between pattern line width and the process time of a step of the first embodiment;

FIG. 9 is a schematic perspective view showing a step of a second embodiment in which the developer is continuously supplied from a developer supply nozzle to the substrate while moving the developer supply nozzle from a circumferential portion of the substrate to the central portion thereof;

FIG. 10 shows a relationship between pattern line width and a step of the second embodiment;

FIG. 11 is a schematic perspective view showing a step of a third embodiment in which a step of continuously supplying the developer from a developer supply nozzle to the substrate while moving the developer supply nozzle from the central portion of the substrate to a circumferential portion thereof, and a step of stopping the supply of the developer from the developer supply nozzle to the substrate are alternatively repeated for a plurality of times;

FIG. 12(a) is a schematic perspective view showing the supply step of a fourth embodiment for supplying the developer from a plurality of developer supply nozzles to the central portion and other portions of the substrate;

FIG. 12(b) is a schematic perspective view showing the stopping step of the fourth embodiment in which the supply of the developer from the developer supply nozzles to the substrate is stopped;

FIG. 13 is a flowchart showing the developing sequence of a fifth embodiment;

FIG. 14(a) is a schematic perspective view showing the liquid film forming step of the fifth embodiment;

FIG. 14(b) is a schematic perspective view showing the developing step of the fifth embodiment; and

FIG. 14(c) is a schematic perspective view showing the cleaning forming step of the fifth embodiment for washing away the resist components dissolved in the developer during the developing step.

### DESCRIPTION OF THE PREFERRED EMBODIMENTS

Embodiments of the present invention will be described hereunder with reference to the accompanying drawings. Here, cases in which a developing apparatus according to the present invention is applied to a coating/developing apparatus are described.

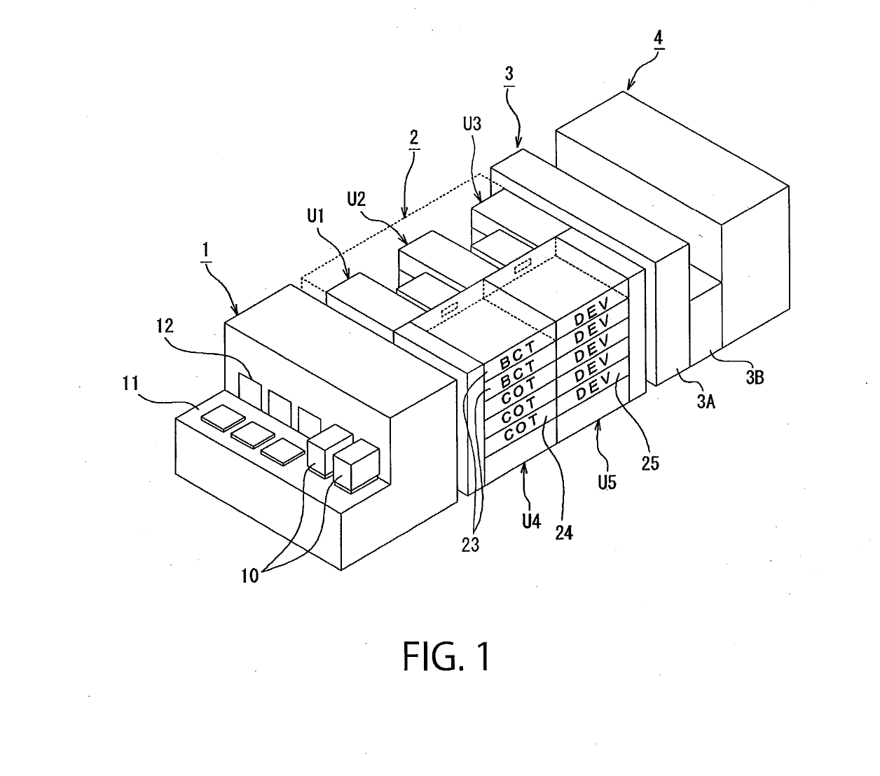

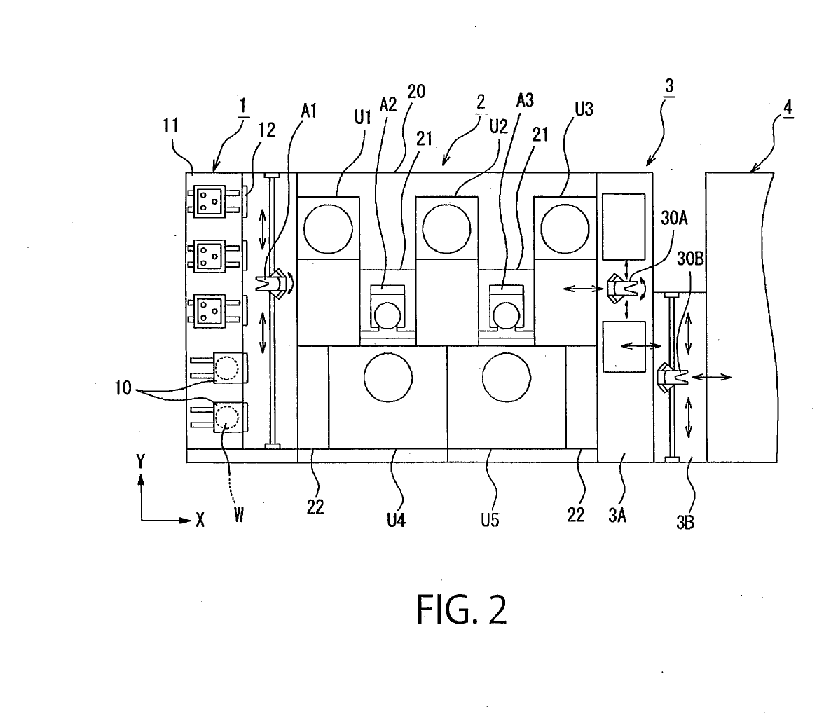

As shown in FIGS. 1 and 2, the processing system includes: a carrier station 1 for loading/unloading carriers 10 which each hermetically accommodates a plurality of, for example, 25 semiconductor wafers W as substrates; a processing section 2 for conducting a resist-coating process, developing process, etc. upon a wafer W unloaded from the carrier station 1; an exposure section 4 for conducting immersion exposure upon the surface of a wafer W in a state where a light-transmitting liquid layer is formed over the wafer surface; and an interface section 3 connected between the processing section 2 and the exposure section 4 for delivering a wafer W between them.

The carrier station 1 includes a mounting section 11 on which the plurality of carriers 10 can be mounted in a line, open/close sections 12 provided on the wall in front of the mounting section 11, and a transfer means A1 for unloading a wafer W from a carrier 10 via the corresponding open/close section 12.

The interface section 3 is constituted by a first transport chamber 3A and a second transport chamber 3B located front and rear between the processing section 2 and the exposure section 4. The first transport chamber 3A and the second transport chamber 3B are provided with a first wafer-transport unit 30A and a second wafer-transport unit 30B, respectively.

The rear side of the carrier station 1 is connected to the processing section 2 surrounded by an enclosure 20. The processing section 2 is provided with, from the front side, rack units U1, U2, and U3 which are multi-staged units consisting of baking/cooling units, liquid treatment units U4 and U5, and main transport means A2 and A3 for transporting the wafer between the rack units and the liquid treatment units. The units and transport means are arranged alternatively. Further, the main transport sections A2, A3 are arranged inside the spaces surrounded by partition walls 21. The four sides of the partition walls 21 are: the two sides facing the rack units U1, U2, U3 arranged in front and back directions as viewed from the carrier station 1; the side facing, for example, the right side which is the side the liquid treatment units U4, U5 further described later are located; and a back side that forms the left side. In addition, temperature/humidity control units 22 are arranged between the carrier station 1 and the processing section 2 and also between the processing section 2 and the interface section 3. Each temperature/humidity control unit 22 includes components for controlling the temperature and humidity of the process liquids used in each unit such as a temperature controller and a temperature/humidity control duct.

The rack units U1, U2, U3 have a configuration such that various units for conducting the pretreatment and posttreatment for the treatments performed in the liquid treatment units U4, U5 are stacked in a plurality of, for example, ten stages. The combination includes units such as a baking unit (not shown) for baking (heating) the wafer W, and a cooling unit (not shown) for cooling the wafer W. The liquid treatment units U4, U5, as shown in FIG. 1, have a multi-staged configuration of, for example, five stages, including an anti-reflection film coating unit (BCT) 23 for coating anti-reflection film over a chemical storage unit for chemicals such as a resist and developer, coating units (COT) 24, and developing unit (DEV) 25 for conducting developing by supplying a developer to a wafer W. The developing apparatus 50 according to the present invention is provided in the developing units (DEVs) 25.

An example of a flow of a wafer processed in the coating/developing apparatus configured as above is briefly described below referring to FIGS. 1 and 2. First, when a carrier 10 accommodating, for example, 25 wafers W is rested on the mounting section 11, the cap of the carrier 10 and the corresponding opening/closing section 12 is removed. A wafer W is then unloaded from the carrier 10 by the transfer means A1 and transferred to the main transport means A2 via a transfer unit (not shown) which is one of the stages constituting the rack unit U1. After being subjected to the pretreatment for coating, for example anti-reflection film formation and cooling, the wafer W is coated with a resist solution in a coating unit (COT) 24. Next, the main transport means A2 transports the wafer W to a baking unit which is one of the racks constituting the rack unit U1, U2 to thereby bake the wafer W. After being cooled, the wafer W is loaded into the interface section 3 via a transfer unit of the rack unit U3. Inside the interface section 3, the wafer W is transported to the exposure section 4 by the first wafer-transport unit 30A of the first transport chamber 3A and the second wafer-transport unit 30B of the second transport chamber 3B. Then, an exposure means (not shown) is positioned so that it opposes the surface of the wafer W and exposure is conducted. After the exposure, the wafer W is transported to the main transport means A3 through the reverse route. The pattern is formed by being developed in a developing unit DEV. The wafer W then returns to the carrier 10 rested on the mounting section 11 in which the wafer was originally accommodated.

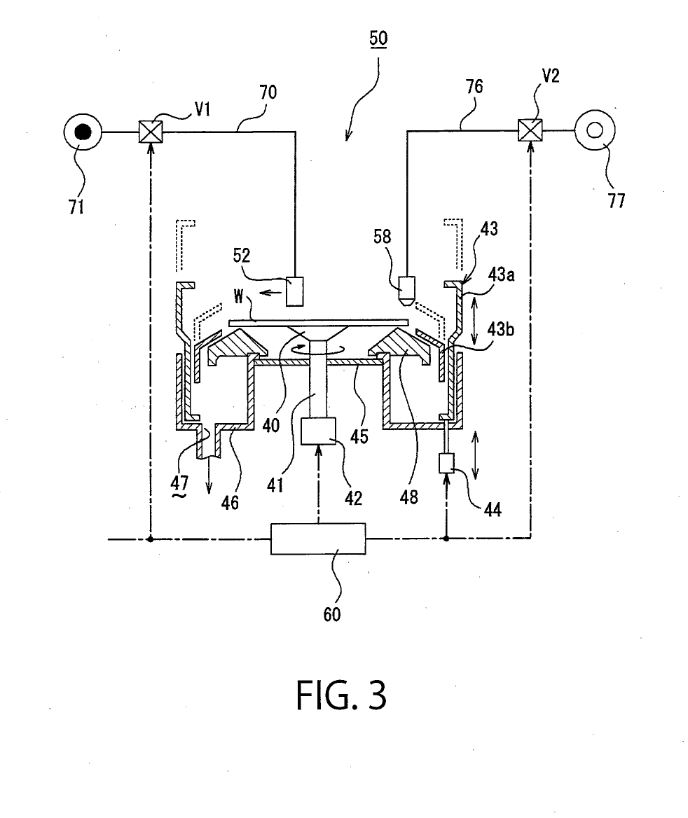

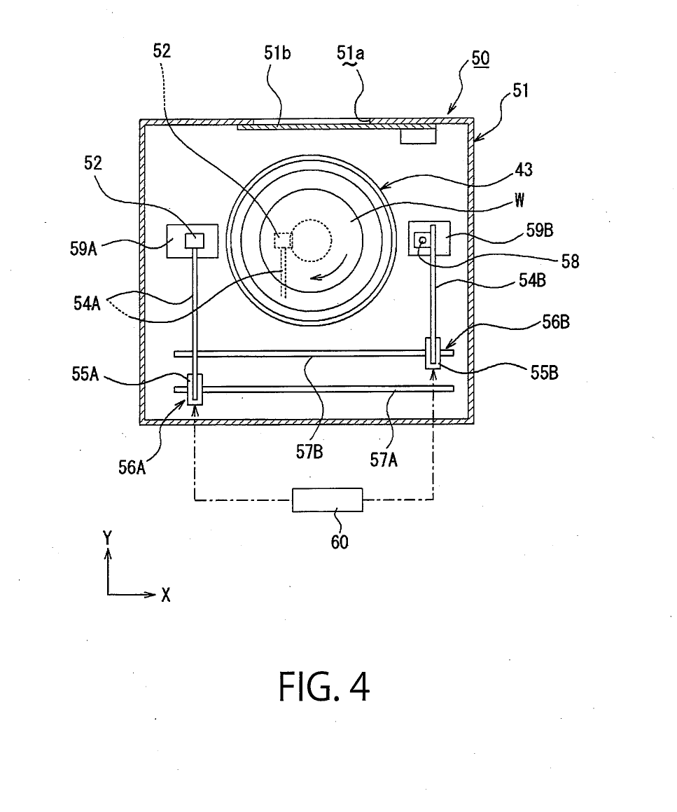

Next, the developing apparatus 50 according to the present invention is described in further detail below. As shown in FIGS. 3 and 4, the developing apparatus 50 has a casing 51 having a wafer loading/unloading port 51a and, within the casing 51a, equipped with a spin chuck 40 that forms a substrate retainer that retains the wafer W horizontally by sucking the lower central portion of the wafer W. The loading/unloading port 51a has a shutter 51b that can be opened and closed.

The spin chuck 40 is coupled to a rotation driving mechanism 42 such as a servomotor via a shaft 41, and is configured to be rotatable by the rotation driving mechanism 42 while retaining the wafer W. The rotation driving mechanism 42 is electrically connected to a controller 60 which is the control unit of the present invention so that the rotational speed of the spin chuck 40 can be controlled according to a control signal from the controller 60.

The developing apparatus 50 also has a cup 43 surrounding the lateral sides of the wafer W retained by the spin chuck 40. The cup 43 includes a cylindrical outer cup 43a and a tubular inner cup 43b inclined inward at its upper edge. The cup 43 is constructed such that the outer cup 43a is vertically moved by a lifting mechanism 44, a cylinder for example, connected to the lower end of the outer cup 43a. The outer cup 43a has a step portion formed along the inner peripheral surface at its lower end, which pushes upward the inner cup 43b so that is can move vertically. The lifting mechanism 44 is electrically connected to the controller 60, and the outer cup 43a is vertically moved according to a control signal from the controller 60.

In addition, a circular plate 45 is provided below the spin chuck 40, and outside the circular plate 45, a liquid receiver 46 having a concave cross section is provided along its whole circumference. A drain port 47 is formed at the bottom of the liquid receiver 46, through which the developer or rinsing liquid that has dripped down or been swept from the spinning wafer W and then stored in the liquid receiver 46 is discharged to the exterior of the apparatus. A ring member 48 having a mountain-like cross section is also provided along the outside of the circular plate 45. Although not shown, for example three lift pins, i.e., substrate support pins extending through the circular plate 45 are provided. The lift pins and substrate transport means not shown work in combination to transfer the wafer W to the spin chuck 40.

Above the wafer W retained by the spin chuck 40, a developer supply nozzle 52 (hereinafter, simply referred to as a developing nozzle 52) is provided in such a manner that it faces the central portion of the wafer W surface via a space and is able to move vertically and horizontally. The developing nozzle 52 in this case has a circular jetting port (not shown) for supplying (jetting) the developer from the leading end of the nozzle.

The developing nozzle 52 is supported at one end of a nozzle arm 54A. The other end of the nozzle arm 54A is coupled to a movable base 55A equipped with a lifting mechanism not shown. The mounting base 55A is configured to be transversely movable along a guide member 57A extending in the X direction by a developer supply nozzle moving mechanism 56A (hereinafter simply referred to as a developing nozzle moving mechanism 56A). Examples of the developing nozzle moving mechanism 56A are a ball screw, a timing belt, and so on. By driving the developing nozzle moving mechanism 56A, the developing nozzle 52 can move along the line (radius) extending from the central portion of the wafer W towards its periphery.

A stand-by section 59A for the developing nozzle 52 is provided at one side outside the cup 43, in which the leading end of the developing nozzle 52 is cleaned, etc.

In addition, above the wafer W retained by the spin chuck 40, a rinsing liquid supply nozzle 58 (hereinafter, referred to simply as the rinsing nozzle 58) is provided in such a manner that it faces the central portion of the wafer W surface via a space and is able to move vertically and horizontally.

The rinsing nozzle 58 is retained at one end of a nozzle arm 54B such that the nozzle 58 and the arm 54B are parallel to each other. The other end of the nozzle arm 54B is coupled to a movable base 55B equipped with a lifting mechanism not shown. The movable base 55B is configured to be transversely movable along a guide member 57B extending in the X direction, i.e., able to move radially from the center of the substrate to the periphery thereof, by a rinsing liquid supply nozzle moving mechanism 56B (hereinafter simply referred to as a rinsing nozzle moving mechanism 56B). Examples of the rinsing nozzle moving mechanism 56B are a ball screw, a timing belt, and so on. A stand-by section 59B for the rinsing nozzle 58 is provided at one side outside the cup 43.

The developing nozzle 52 is connected to a developer supply source 71 via a developer supply line 70 equipped with an open/close valve V1. On the other hand, the rinsing nozzle 58 is connected to a rinsing liquid supply source 77 which is the cleaning liquid source supply source via a rinsing liquid supply line 76 equipped with an open/close valve V2.

The developing nozzle moving mechanism 56A, the rinsing nozzle moving mechanism 56B, and the open/close valves V1, V2 are each electrically connected to the controller 60. The horizontal movement of the developing nozzle 52 and the rinsing nozzle 58, and open/close driving of the open/close valves V1, V2 are performed in accordance with control signals previously stored in the controller 60. By controlling open/close driving of the open/close valve V1 with the controller 60, supply of the developer from the developing nozzle 52 to the wafer W can be controlled.

As the developer supplied to the wafer W from the developing nozzle 52 configured as above, a developer containing organic solvent can be used. Such developer can form a pattern by selectively dissolving and removing, among the whole area where resist film has been exposed in the exposure process, the portions irradiated with low light intensity. Examples of the developer containing organic solvent are polar solvents such as ketone solvents, ester solvents, alcohol solvents, and amid solvents; and hydrocarbon solvents. The developer used in the present embodiment is an ester solvent containing butyl acetate.

On the other hand, as the rinsing liquid supplied from the rinsing nozzle 58 to the wafer W, a rinsing liquid containing organic solvent is used. The rinsing liquid may be a rinsing liquid contains, for example, an alcohol that has a carbon number of at least five, has an alkyl chain of at least one of a branch structure and a ring structure, and the secondary or tertiary carbon atom of the alkyl chain is bonded to a hydroxyl group. Another example is one that contains a dialkyl ether that has at least one of an alkyl group having a carbon number of at least 5 and a cycloalkyl group having a carbon number of at least 5. The rinsing liquid used in the present embodiment is a rinsing liquid containing 4-methyl-2-pentanol (MIBC), an alcohol that is applicable.

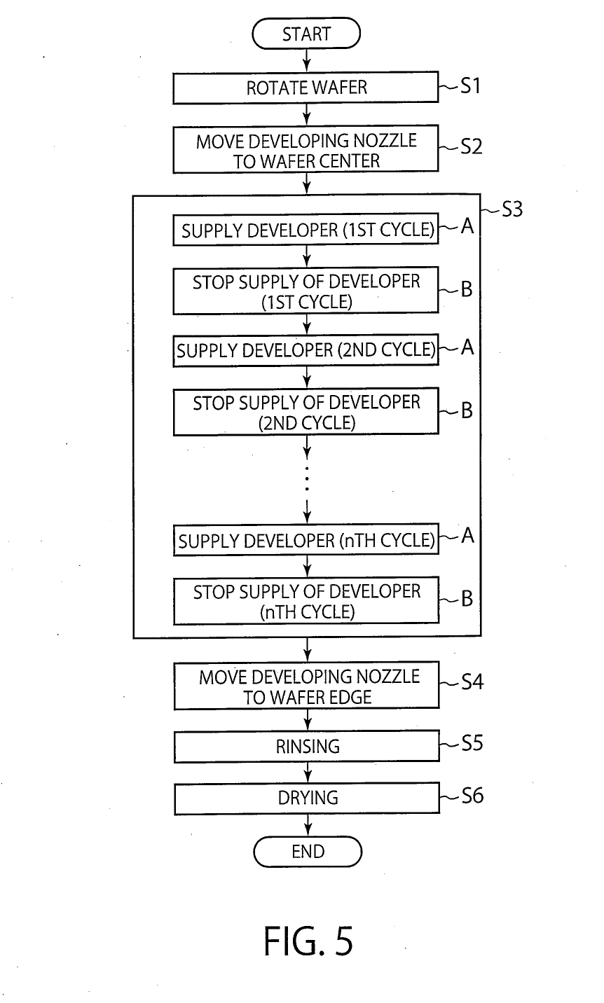

Next, a first embodiment of wafer developing by the developing apparatus 50 having the above configuration is described below. FIG. 5 is a flowchart showing the developing process of the first embodiment. The steps proceed in the direction of the arrow. In the first embodiment, a wafer W with a diameter of 300 mm is developed.

First, the wafer W is transported to the spin chuck 40 by the transport means not shown. The wafer W is retained by the spin chuck 40, and the rotation driving mechanism 42 is activated to rotate the wafer W at a speed of, for example, 1,000 rpm (step S1). Then, the developing nozzle moving mechanism 56A is driven to move the developing nozzle 52 from the periphery of the wafer W to a position above its central portion (step S2).

The order of steps S1 and S2 may be reversed. That is to say, the developing nozzle 52 may ahead be moved from the periphery of the wafer W to a position above its central portion, and then the wafer W may be rotated at a speed of, for example, 1,000 rpm by activating the rotation driving mechanism 42.

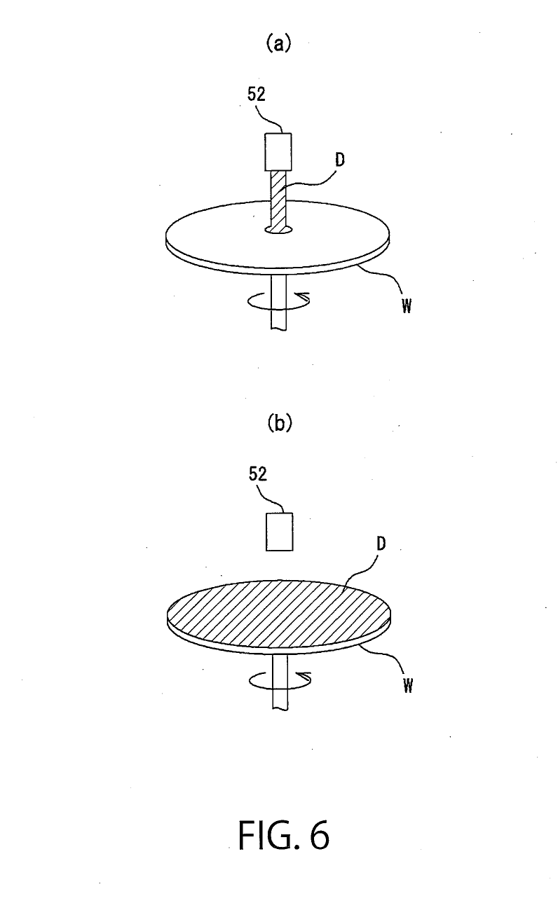

Next, the developer is supplied from the developing nozzle 52 to the central portion of the wafer W (step S3). Step S3 includes a liquid film forming step (step A: see FIG. 6(a)) and a developing step (step B: see FIG. 6(b)). The liquid film forming step (step A) is a step for forming a liquid film by supplying the developer D from the developing nozzle 52 to the central portion of the wafer W while rotating the wafer W, and the developing step (step B) is a step for stopping the supply of the developer D from the developing nozzle 52 to the wafer W and developing the resist film. The liquid film forming step A and developing step B are performed alternatively for a plurality of times.

First, the liquid film forming step A of the first cycle is conducted. The developer D is supplied from the developing nozzle 52 to the central portion of the wafer W rotating at a speed of, for example, 1,000 rpm, to thereby form a liquid film. The developer D is supplied from the developing nozzle 52 at a flow velocity of, for example, 300 ml/min, and the developer supply time period T from the start to the end of the developer D supply is 0.5 seconds.

Next, the developing step B of the first cycle follows. The resist film on the wafer W is developed while the wafer W is rotated at a speed of, for example, 1,000 rpm. The developer stopping time period P from the stop to the next supply of the developer D is 1.5 seconds. In the developing step, if the supply of the developer D is stopped while the wafer W is rotating at 1,000 rpm, drying of the wafer W is liable to accelerate. As to suppress the drying, for example, a rectification plate may be provided over a part of the wafer W, or the wafer W may be entirely shrouded with a cover to suppress volatilization of the developer D. Incidentally in the developing step, the drying of the developer can be suppressed by reducing the rotational speed of the wafer W to 100 rpm. The drying may also be suppressed by controlling at least one of the temperatures of the wafer W and the developer within the range from 18° C. to 21° C., or by narrowing the opening of the cup 43 (specifically, the outer cup 43a) to 30 mm or smaller.

Next, the liquid film forming step A of the second cycle is conducted similarly to the first liquid film forming step, and following it, the developing step B of the second cycle is conducted similarly to the first developing step.

The liquid film forming step A and developing step B are alternatively performed for a plurality of times, for example eight times (n=8), thereby accomplishing step S3.

Next, the developing nozzle moving mechanism 56A is activated to move the developing nozzle 52 from the central portion of the wafer W to the periphery (step S4).

After the developer has been supplied from the developing nozzle 52 to the wafer W as described above, the rinsing nozzle moving mechanism 56B is driven to move the rinsing nozzle 58 to a position above the central portion of the wafer surface. The rinsing liquid containing organic solvent is supplied from the rinsing nozzle 58 to the surface of the wafer W rotating at, for example, 1,000 rpm (step S5). The rinsing liquid is supplied from the rinsing nozzle 58 at a flow velocity of 120 ml/min, for example, and the supply time period T of the rinsing liquid from the start to the end of its supply is 5 seconds. The rinsing liquid supplied from the rinsing nozzle 58 stops dissolution of the resist film caused by the developer, and washes away the developer on the wafer surface containing the dissolved resist components.

In the rinsing process of step S5, instead of the rinsing liquid, the organic developer used in step S3 may be used in order to wash away the existing developer containing the dissolved resist components from the wafer surface. In this case, in addition to the supplying of the organic developer from the developing nozzle 52 to the central portion of the wafer W, the organic developer may also be supplied while the developing nozzle 52 is being moved from the central portion of the wafer W to the circumferential portion, or vice versa, while the developing nozzle 52 is being moved from the circumferential portion to the central portion.

Next, the rotation driving mechanism 42 is activated to rotate the wafer W at a high speed, for example 2,000 rpm, and a spin-dry process for 20 seconds in order to sweep or fling away the liquid on the wafer surface (step S6).

The first embodiment includes the liquid film forming step for forming a liquid film by supplying the developer from the developing nozzle 52 to the central portion of the wafer W, and the developing step in which the supply of the developer D from the developing nozzle 52 to the wafer W is stopped to develop the resist film. Since the two steps are alternatively performed for a plurality of times, the liquid film of the developer formed over the wafer W surface can be kept thin, which increases the resist film dissolution/removal speed. Therefore, the process time of the developing can be reduced, resulting in an improved throughput.

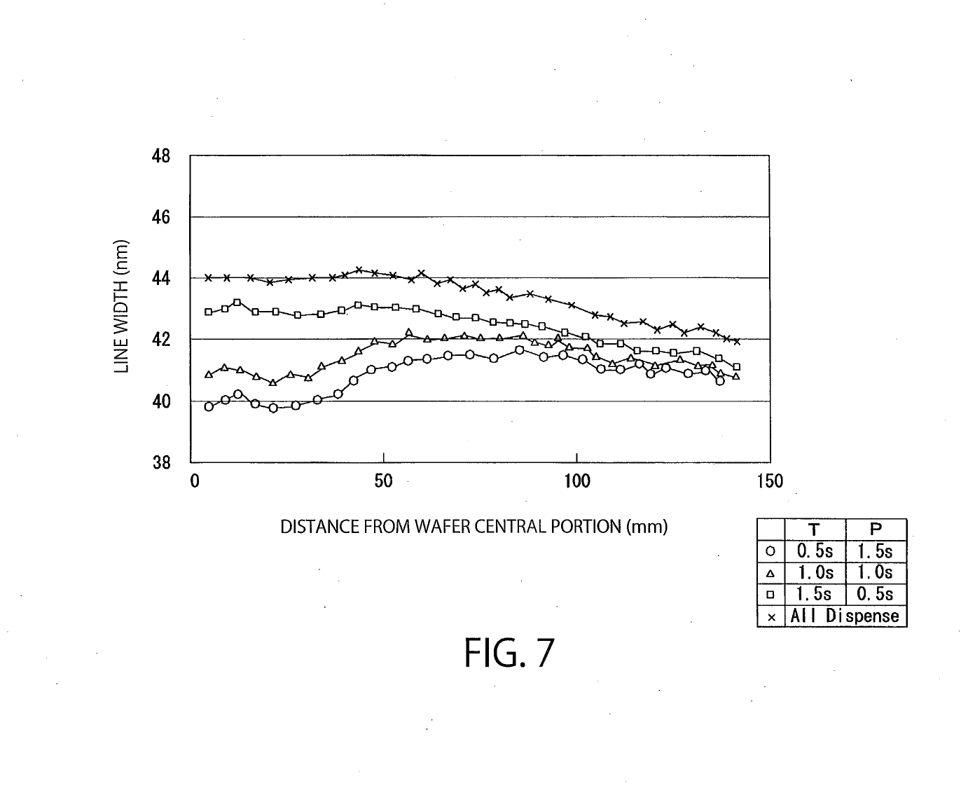

As an experiment, wafers W having a diameter of 300 mm were supplied with the developer for 20 seconds at different process conditions: “∘” (developer supply time period T/developer stopping time period P: 0.5 s/1.5 s); “Δ” (developer supply time period T/developer stopping time period P: 1.0 s/1.0 s); “□” (developer supply time period T/developer stopping time period P: 1.5 s/0.5 s); and “x” (All Dispense). After performing the rinsing and drying processes, the line widths of the pattern at each portion from the central portion to the circumferential portion of the wafer W were measured. The experimental results are shown in FIG. 7.

As can be seen in FIG. 7, the wafer W processed with the process condition “x” (All Dispense), processed by continuously supplying the developer to the wafer W from the developing nozzle 52 without the developing step for stopping the supply, had thick pattern line width and slow resist film dissolution/removal speed at each portion from the central portion to the periphery of the wafer W compared to those processed with the other process conditions “∘” (T/P: 0.5 s/1.5 s), “Δ” (T/P: 1.0 s/1.0 s), and “∘” (T/P: 1.5 s/0.5 s) which were set with the developing step.

Next, the other three process conditions that include the developing step in which supply of the developer from the developing nozzle 52 to the wafer W is stopped, namely, “∘” (T/P: 0.5 s/1.5 s), “Δ” (T/P: 1.0 s/1.0 s), and “∘” (T/P: 1.5 s/0.5 s), are compared. The process condition “∘” (T/P: 0.5 s/1.5 s) having the shortest developer supply time period T showed the thinnest pattern line widths and highest resist film dissolution/removal speeds.

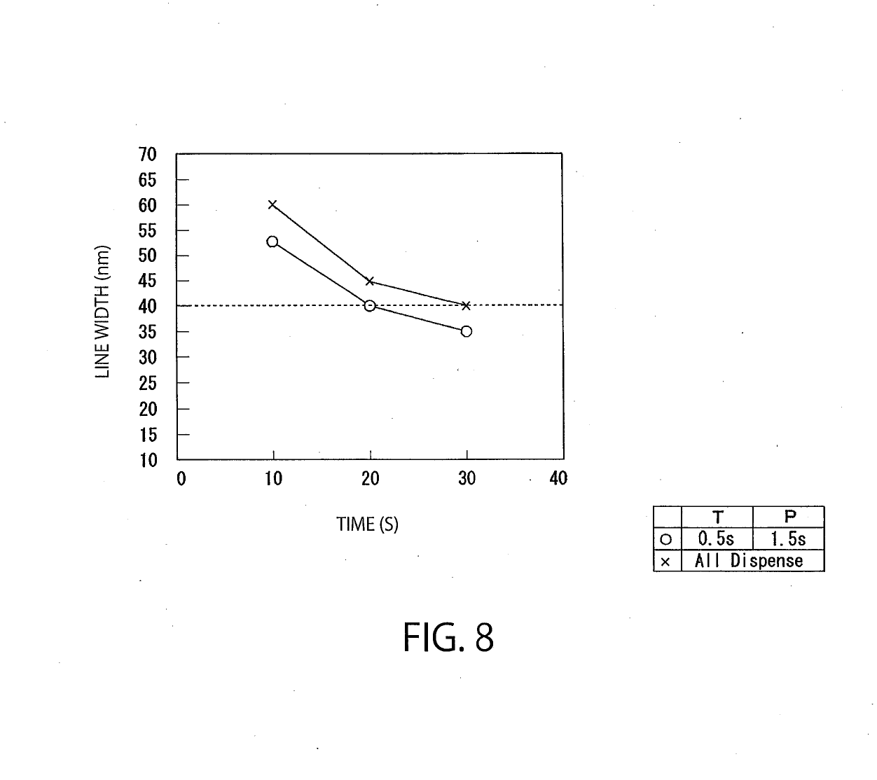

FIG. 8 shows the experimental results of another experiment. In this experiment, wafers W with a diameter of 300 mm were supplied with the developer under two different process conditions: “x” (All Dispense), in which the developer is continuously supplied to the wafer W from the developing nozzle 52 without the developing step in which the supply is stopped; and “∘” (developer supply time period T/developer stopping time period P: 0.5 s/1.5 s). After that, the wafers W were subjected to rinsing and drying, and the pattern line widths of the central portion of the wafers W were measured per elapsed process time.

As shown in FIG. 8, assuming that the target line width is 40 nm, while 30 seconds of process time is required for the process condition “x” (All Dispense), the target line width can be attained with 20 seconds of process time for the process condition “∘” (T/P: 0.5 s/1.5 s). This indicates that the process condition “∘” (T/P: 0.5 s/1.5 s) including the step of stopping the supply of developer from the developing nozzle 52 to the wafer W requires shorter process time to obtain the target line width.

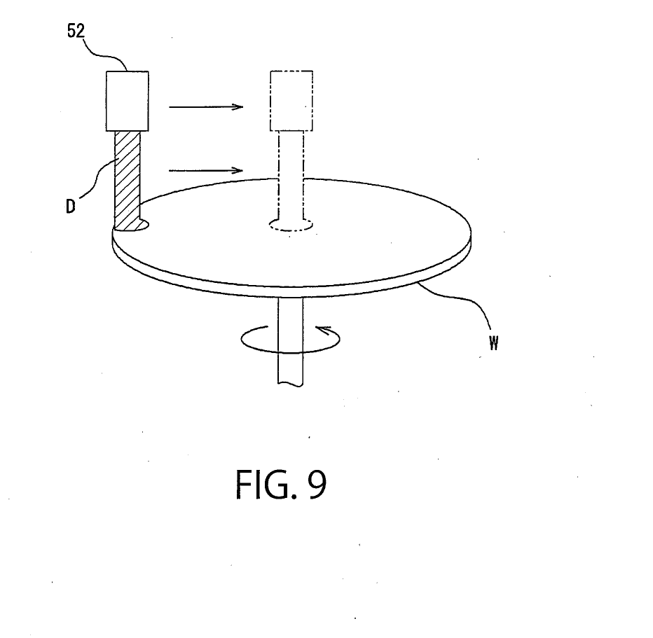

In the first embodiment, the developing nozzle moving mechanism 56A was driven to move the developing nozzle 52 from the periphery to a position above the central portion of the wafer W (step S2). However, as shown in FIG. 9, for example, the developer D may be continuously supplied from the developing nozzle 52 to the wafer W while moving the developing nozzle 52 from the circumferential portion of the wafer W to the central portion thereof (step S2a: not shown). To continuously supply the developer means that the developer is continuously supplied from the developing nozzle 52 to the wafer W without having the step of stopping the supply of developer from the developing nozzle 52 to the wafer W.

A second embodiment of wafer developing by the developing apparatus 50 is next described below. As with the first embodiment, first, a wafer W is transported to the spin chuck 40 by transport means not shown. The wafer W is retained by the spin chuck 40, and the rotation driving mechanism 42 is activated to rotate the wafer W at a speed of, for example, 1,000 rpm (step S1).

Next as shown in FIG. 9, the developing nozzle moving mechanism 56A is driven to move the developing nozzle 52 from the circumferential portion of the wafer W to a position above the central portion of the wafer at a speed of 40 mm/s. At the same time, while moving the developing nozzle 52, the developer D is continuously supplied at a flow velocity of, for example, 300 ml/min from the developing nozzle 52 (step S2a). Subsequent process steps S3 to S6 are conducted similarly as performed in the first embodiment.

In the second embodiment, before the developer D is supplied from the developing nozzle 52 to the central portion of the wafer W, the developer is continuously supplied from the developing nozzle 52 to the rotating wafer W while the developing nozzle 52 is moving from the circumferential portion of the wafer W to the central portion thereof. Thus, dissolution/removal of the resist film can be started from the time point of the step of moving the developing nozzle 52 from the circumferential portion to the central portion of the wafer W. Therefore, the time required for the developing process can be reduced, which results in improvement of throughput. In addition, more uniform developing can be performed over the entire wafer surface by supplying the developer D to portions of the wafer W other than the central portion.

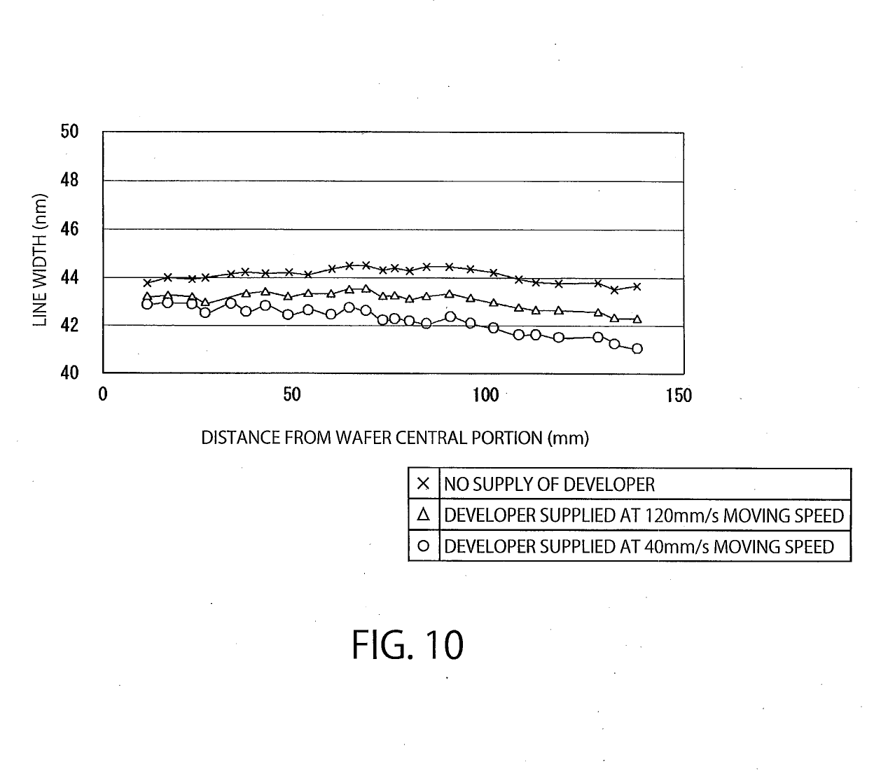

FIG. 10 shows the experimental results of another experiment. Wafers W having a diameter of 300 mm were rotated at 1000 rpm. The developing nozzle 52 was moved from the circumferential portion to a position above the central portion of the wafer W with different process conditions: “x” (developer not supplied during nozzle movement); “Δ” (developer supplied: moving speed of the developing nozzle 52 at 120 mm/s, flow rate of the developer at 300 ml/min); and “∘” (developer supplied: moving speed of the developing nozzle 52 at 40 mm/s, flow rate of the developer at 300 ml/min). Then, the developer was supplied to the wafer W at its central portion for 16 seconds with the developer supply time period T/developer stopping time period P each set as 1.0 s/1.0 s. After rinsing and drying, the pattern line widths of each portion of the wafer W from its central portion to circumferential portion were measured.

As shown in FIG. 10, compared to the process condition “x” (developer not supplied during nozzle movement) in which the developer was not supplied from the developing nozzle 52 to the wafer W, the other process conditions, which included the step of continuously supplying the developer from the developing nozzle 52 to the wafer W while moving the developing nozzle 52 from the circumferential portion of the wafer W to the central portion, showed thinner pattern line widths: “Δ” (developer supplied: moving speed of the developing nozzle 52 at 120 mm/s, flow rate of the developer at 300 ml/min), and “∘” (developer supplied: moving speed of the developing nozzle 52 at 40 mm/s, flow rate of the developer at 300 ml/min).

Next, the two processes that included the step of continuously supplying the developer from the developing nozzle 52 to the wafer W while moving the developing nozzle 52 from the circumferential portion of the wafer W to the central portion, “Δ” (developer supplied: moving speed of the developing nozzle 52 at 120 mm/s, flow rate of the developer at 300 ml/min) and “∘” (developer supplied: moving speed of the developing nozzle 52 at 40 mm/s, flow rate of the developer at 300 ml/min), are compared. The process condition “∘” (developer supplied: moving speed of the developing nozzle 52 at 40 mm/s, flow rate of the developer at 300 ml/min) having the slower moving speed of the developing nozzle 52 showed the thinnest pattern line widths.

The above results indicate that by continuously supplying the developer from the developing nozzle 52 to the wafer W while moving the developing nozzle 52 from the circumferential portion of the wafer W to its central portion in step 2a, pattern line width can be controlled. In addition, it was found that pattern line width can be controlled by the moving speed of the developing nozzle 52.

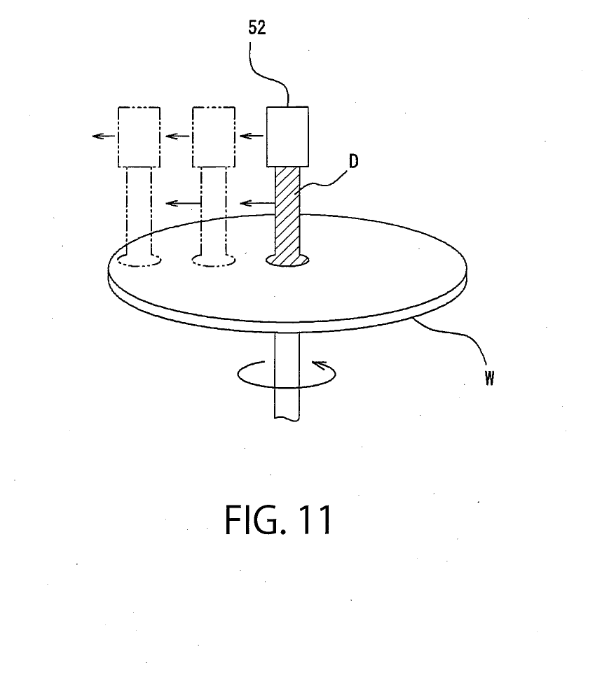

In the first embodiment, the developing nozzle 52 was moved from the central portion of the wafer W to the circumferential portion thereof with the supply of the developer being stopped (step S4). However, as shown in FIG. 11, for example, the step of supplying the developer D from the developing nozzle 52 to the wafer W while moving the developing nozzle 52 from the central portion of the wafer W to the circumferential edge thereof, and the step of stopping the supply of the developer D from the developing nozzle 52 to the wafer W may be alternatively repeated for a plurality of times (step S4a: not shown).

A third embodiment of wafer developing by the developing apparatus 50 is described below. Process steps S1 to S3 are conducted similarly as performed in the first embodiment.

Then, as shown in FIG. 11, the step of activating the developing nozzle moving mechanism 56A to supply the developer from the developing nozzle 52 to the wafer W at a velocity of, for example, 300 ml/min while moving the developing nozzle 52 at a speed of 40 mm/s from the central portion of the wafer W to the circumferential portion thereof, and the step of stopping the supply of the developer from the developing nozzle 52 to the wafer W, are alternatively repeated for a plurality of times (step S4a). The following process steps S5 and S6 are conducted similarly as performed in the first embodiment.

In the third embodiment, after the developer has been supplied from the developing nozzle 52 to the central portion of the wafer W, while rotating the wafer W, the step of supplying the developer from the developing nozzle 52 to the wafer W while moving the developing nozzle 52 from the central portion of the wafer W to the circumferential portion thereof, and the step of stopping the supply of the developer from the developing nozzle 52 to the wafer W are alternatively repeated for a plurality of times. Thus, even in the step of moving the developing nozzle 52 from the central portion of the wafer W to the circumferential portion, the resist film can be dissolved and removed by supplying the developer to the wafer W. Therefore, the process time required for developing is reduced, thereby improving throughput. In addition, more uniform developing can be performed over the entire wafer surface by supplying the developer to portions of the wafer W other than the central portion.

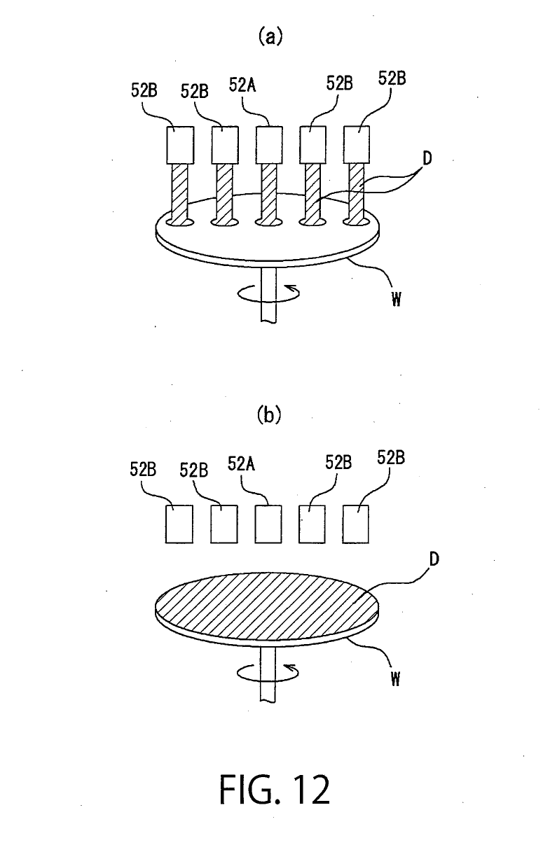

In the foregoing first embodiment, the developer has been supplied from one developing nozzle 52 to the central portion of the wafer W (step S3). However, as shown in FIG. 12(a) and (b), for example, a plurality of, e.g., five developing nozzles may be provided. The developer D may be supplied from one developing nozzle 52A to the central portion of the wafer W, and at the same time, from four developing nozzles 52B to portions of the wafer W other than the central portion (step S3a: not shown).

A fourth embodiment of wafer developing by the developing apparatus 50 is described below. Process steps S1 and S2 are conducted similarly as performed in the first embodiment. In step S2, the developing nozzle 52A is disposed above the central portion of the wafer W, and the four developing nozzles 52B are disposed above portions of the wafer W other than the central portion in such a manner that two developing nozzles 52B are symmetrically disposed at each of the left side and right side across the developing nozzle 52A. The layout is shown in FIG. 12(a) and (b).

Next, the developer D is supplied from the developing nozzles 52A and 52B to the central and other portions of the wafer W (step S3a). Step S3a includes a liquid film formation step Aa (not shown) and a developing step Ba (not shown), as shown in FIG. 12(a) and (b). The liquid film formation step Aa is a step for forming a liquid film by supplying the developer D from the developing nozzles 52A, 52B to the central and other portions of the wafer W while rotating the wafer. The developing step Ba is a step for developing the resist film by stopping the supply of the developer from the developing nozzles 52A, 52B to the wafer W while rotating the wafer. The liquid film forming step Aa and developing step Ba are alternatively performed for a plurality of times.

First, the liquid film forming step Aa of the first cycle is performed. The developer D is supplied from the developing nozzles 52A, 52B to the central portion and other portions of the wafer W rotating at a speed of, for example, 1,000 rpm. The developer D is supplied from the developing nozzles 52A, 52B at a flow velocity of, for example, 60 ml/min, and the supply time period T of the developer D from the start to the end of the supply is 0.5 seconds.

Next, the developing step Ba of the first cycle follows. The developer is supplied to the wafer W rotating at a speed of 1,000 rpm, for example. The developer stopping time period P from the stop to the next supply of the developer D is 1.5 seconds.

Next, the liquid film forming step Aa of the second cycle is conducted similarly to the first liquid-film forming step, and following it, the developing step Ba of the second cycle is conducted similarly to the first developing step.

Step S3a can be accomplished by alternatively repeating the liquid film forming step Aa and developing step Ba a plurality of times, for example eight times (n=8). The following process steps S4 to S6 are conducted similarly as performed in the first embodiment.

In the fourth embodiment, the plurality of developing nozzles, 52A and 52B, are provided. In the liquid film forming step, the developer is supplied from the developing nozzles 52A, 52B to the central other portions of the wafer W, and in the developing step, the supply of the developer from the developing nozzles 52A, 52B to the wafer W is stopped. Since the developer can be supplied from the developing nozzles 52A, 52B to the central and other portions of the wafer W, the process time required for developing is reduced, resulting in improved throughput. In addition, more uniform developing over the entire wafer surface can be performed by supplying the developer to portions of the wafer W other than the central portion.

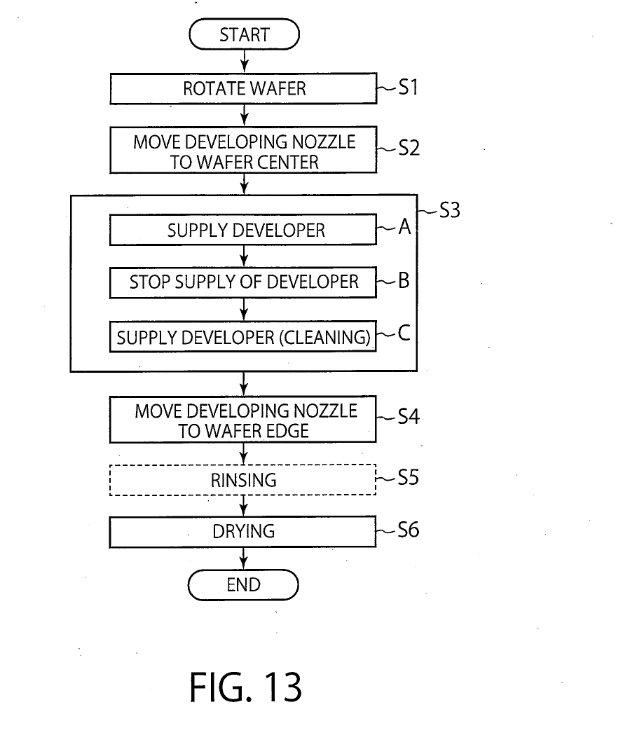

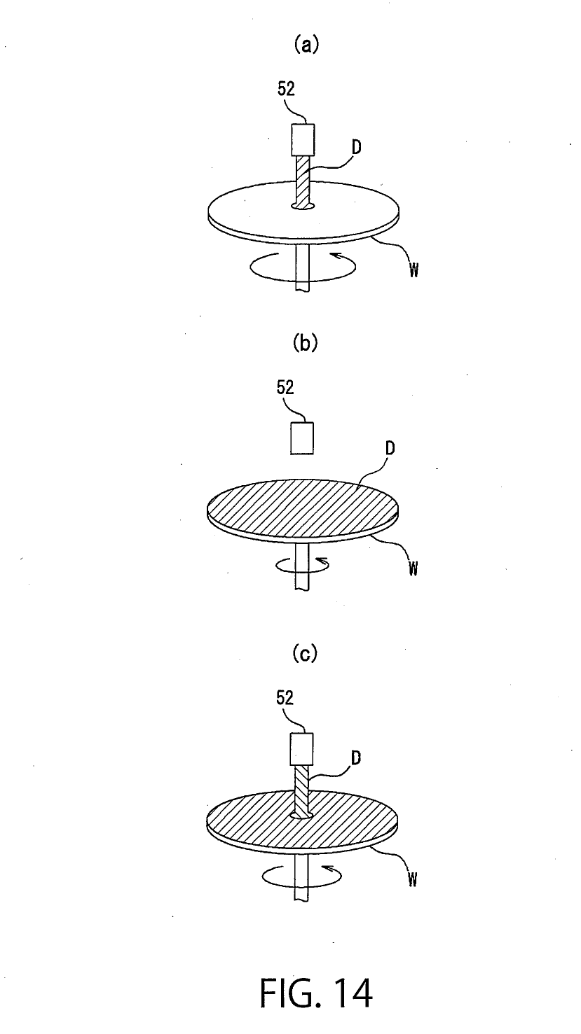

Next, a fifth embodiment of wafer developing by the developing apparatus 50 having the foregoing configuration is described below referring to a flowchart shown in FIG. 13 and schematic perspective views shown in FIGS. 14(a) to 14(c).

First, a wafer W is transported to the spin chuck 40 by a transport means not shown. The wafer W is retained by the spin chuck 40, and the rotation driving mechanism 42 is activated to rotate the wafer W at a speed of, for example, 1,000 rpm (step S1). After this, the developing nozzle moving mechanism 56A is driven to move the developing nozzle 52 from the circumferential portion of the wafer W to a position above the central portion of the wafer (step S2).

The order of steps S1 and S2 may be reversed. That is to say, the developing nozzle 52 may be moved from the circumferential portion of the wafer W to the position above the central portion of the wafer before rotating the wafer W at a speed of, for example, 1,000 rpm by the activation of the rotation driving mechanism 42.

Next, the developer is supplied from the developing nozzle 52 to the central portion of the wafer W (step S3). Step S3 includes three sub-steps: a liquid film forming step A (see FIG. 14(a)), a developing step B (see FIG. 14(b)), and a cleaning step C (see FIG. 14(c)). The liquid forming step A is a step for forming a liquid film by supplying the developer D from the developing nozzle 52 to the central portion of the wafer W while rotating the wafer W at a first speed of 1,000 rpm. The developing step B is a step for developing the resist film by stopping the supply of developer D from the developing nozzle 52 to the wafer W. During the developing step B, the wafer W is rotated at a second speed lower than the first speed that will not accelerate drying of the developer, for example 100 rpm. The cleaning step C is a step for washing away the developer containing dissolved resist components by supplying the developer D to the central portion of the wafer W while raising the rotating speed of the wafer W to 1,000 rpm, for example.

Step S3 is described in further details below. First, the liquid film forming step A of the first cycle is conducted. The liquid film is formed by supplying the developer D from the developing nozzle 52 to the central portion of the wafer W rotating at the first speed of 1,000 rpm, for example. The developer D is supplied from the developing nozzle 52 at a flow velocity of 60 ml/min, for example, and the developer D supply time period T from the start to the stop of its supply is 5 seconds. The liquid film of the developer is spread over the entire wafer surface by the liquid film forming step.

The developing step B of the first cycle next follows. The developing is performed while rotating the wafer W at a speed lower than the first speed, for example 100 rpm, so that the resist film on the wafer W is kept thin. The developer stopping time period P from the stop to the next supply of the developer D is 14 seconds. In the developing step, drying of the developer can be suppressed by reducing the rotating speed of the wafer W to 100 rpm, for example. As to suppress the drying, for example, a rectification plate may be provided over a part of the wafer W, or the wafer W may be entirely shrouded with a cover to suppress volatilization of the developer D. The drying may also be suppressed by controlling at least one of the temperatures of the wafer W and the developer within the range from 18° C. to 21° C., or by narrowing the opening of the cup 43 (specifically, the outer cup 43a) to 30 mm or smaller.

It has been described above that in the liquid film forming step, the developer is supplied at a velocity of 60 ml/min for a time period T of 5 seconds, and in the developing step, the supply of the developer is stopped for a time period P of 14 seconds. However, the developer supply stopping time period P may be shortened by reducing the velocity of the developer to below 60 ml/min and extending the developer supply time period T extended to more than 5 seconds.

Step S3 is accomplished by executing the cleaning step C. The developer containing the dissolved resist components is washed away by supplying the developer D to the central portion of the wafer W while raising the rotating speed of the wafer W to 1,000 rpm, for example. In cleaning step C, in addition to the supplying of the organic developer from the developing nozzle 52 to the central portion of the wafer W, the organic developer may be supplied while moving the developing nozzle 52 from the central portion of the wafer W to its circumferential portion, and/or while moving the developing nozzle 52 from the circumferential portion of the wafer W to its central portion.

Next, the developing nozzle moving mechanism 56A is activated to move the developing nozzle 52 from the central portion of the wafer W to the circumferential portion thereof (step S4).

After supplying the developer from the developing nozzle 52 to the wafer W as above, the rinsing process is performed as shown in the broken line in the FIG. 13. The rinsing nozzle moving mechanism 56B is activated to move the rinsing nozzle 58 to a position above the central portion of the wafer surface. The rinsing liquid containing an organic solvent is supplied from the rinsing nozzle 58 to the surface of the wafer W rotating at, for example, 1,000 rpm, to thus perform rinsing (step S5). The flow velocity of the rinsing liquid supplied from the rinsing nozzle 58 is 120 ml/min, for example, and the supply time period of the rinsing liquid from the start to the end of its supply is 5 seconds. The rinsing liquid supplied from the rinsing nozzle 58 stops the dissolution of the resist film by the developer, and washes away the developer on the wafer surface containing the dissolved resist components.

Since the organic developer used in cleaning step S3 washes away the existing developer containing the dissolved resist components on the wafer surface, rinsing step S5 may be skipped and processing may proceed to the following drying process. If drying is to be conducted without performing rinsing, before the drying step, progress of the development of the resist film may be controlled by supplying gas such as an N₂ gas to the central portion of the wafer W. At this time, when the organic developer is supplied while moving the developing nozzle 52 from the central portion of the wafer W to the circumferential portion, or vice versa, the gas is supplied in such a manner that the gas supply position is moved from the central portion of the wafer W to the circumferential portion thereof to form an uniform liquid film of the developer over the wafer W.

In the drying step, the rotation driving mechanism 42 is activated to rotate the wafer W at a high speed, for example 2,000 rpm, and conduct spin drying for 20 seconds to sweep away the liquid on the wafer W surface (step S6).

Incidentally, it has been described above that the rotating speed of the wafer W in the liquid film forming step is 1,000 rpm and the rotating speed of the wafer W in the developing step is 100 rpm. However similar effects can as well be obtained by rotating the wafer W at 100 to 1,500 rpm in the liquid film forming step and rotating the wafer W at 10 to 100 rpm in the developing step. For example, the developing process may be conducted by rotating the wafer W may be at 1,000 rpm in the liquid film forming step, slowing down the rotation of the wafer W to 100 rpm and stopping the supply of the developer in the developing step, and further reducing the rotating speed to 10 rpm. The wafer rotation is not stopped during the developing step because if the rotation stops, the dissolved resist components within the developer would cause a concentration distribution, so that a uniform line width cannot be obtained.

Incidentally, the liquid film forming step and the developing step may be repeated for a plurality of times in the fifth embodiment.

The fifth embodiment includes the liquid film forming step in which a thin liquid film is formed on the wafer W by supplying the developer from the developing nozzle 52 to the central portion of the wafer W while rotating the wafer W, the developing step in which the supply of the developer D from the developing nozzle 52 to the rotating wafer W is stopped and the liquid film formed by the resist on the wafer W is kept thin, and the cleaning step in which the developer containing the dissolved resist components on the wafer surface is washed away. Thus, the liquid film of the developer D formed on the wafer surface can be kept thin, and the resist film dissolution/removal speed can be increased. Therefore, the process time required for developing is reduced, resulting in an improved throughput.

What is claimed is:

1. A developing method for performing developing by supplying a developer containing an organic solvent to a substrate having its surface coated with a resist and exposed, the developing method comprising the steps of:
a liquid film forming step for forming a liquid film by supplying the developer from a developer supply nozzle to a central portion of the substrate while rotating the substrate; and
a developing step for developing the resist film on the substrate while rotating the substrate in a state where the supply of the developer from the developer supply nozzle to the substrate is stopped and in such a manner that the liquid film of the developer would not dry.

2. The developing method according to claim 1, wherein:
in the liquid film forming step, the substrate rotates at a first speed;
in the developing step, the substrate rotates at a speed lower than the first speed that does not accelerate the drying of the liquid film of the developer; and
the developing method further comprises a cleaning step for washing away the existing developer containing the resist components dissolved therein in the developing step by supplying the developer from the developer supply nozzle to the central portion of the substrate while rotating the substrate at a third speed higher than the second speed.

3. The developing method according to claim 2, wherein the first rotating speed is between 100 rpm and 1,500 rpm, and the second rotating speed is between 10 rpm and 100 rpm.

4. The developing method according to claim 1, wherein the liquid film forming step and the developing step are alternatively repeated for a plurality of times.

5. The developing method according to claim 1, further comprising, before the liquid film forming step in which the developer is supplied from the developer supply nozzle to the central portion of the substrate, a step of continuously supplying the developer from the developer supply nozzle to the substrate while rotating the substrate and moving the nozzle from a circumferential portion of the substrate to the central portion thereof.

6. The developing method according to claim 1, wherein, after the liquid film forming step in which the developer is supplied from the developer supply nozzle to the central portion of the substrate, a cleaning step in which the developer is supplied from the developer supply nozzle to the substrate while rotating the substrate and moving the nozzle from the central portion of the substrate to a circumferential portion thereof, and the developing step in which the supply of the developer from the developer supply nozzle to the substrate is stopped, are alternatively repeated for a plurality of times.

7. The developing method according to claim 1, wherein:
a plurality of the developer supply nozzles are provided;
in the liquid film forming step, the developer is supplied from the developer supply nozzles to the central portion of the substrate and portions thereof other than the central portion; and
in the developing step, the supply of the developer from the developer supply nozzles to the substrate is stopped.

8. The developing method according to claim 1, further comprising steps subsequent to the liquid film forming step and the developing step, that is, a step of supplying a rinsing liquid from a rinsing liquid supply nozzle to the substrate while rotating the substrate; and a step for drying the substrate by rotating the substrate after supplying the rinsing liquid from the rinsing liquid supply nozzle to the substrate.

9. A developing apparatus for performing developing by supplying a developer containing an organic solvent to a substrate having its surface coated with a resist and exposed, the developing apparatus comprising:
a substrate retainer for retaining the substrate horizontally;
a rotation driving mechanism for rotating the substrate retainer about a vertical axis;
a developer supply nozzle for supplying the developer to a surface of the substrate retained by the substrate retainer; and
a controller for controlling the rotation driving mechanism and the supply of the developer from the developer supply nozzle to the substrate;
wherein, in accordance with a control signal from the controller, the developing apparatus conducts a liquid film forming process and a developing process, the liquid film forming process forming a liquid film by supplying the developer from the developer supply nozzle to a central portion of the substrate while rotating the substrate, the developing process developing the resist film on the substrate while rotating the substrate in a state where the supply of the developer from the developer supply nozzle to the substrate is stopped and in such a manner that the liquid film of the developer would not dry.

10. The developing apparatus according to claim 9, wherein:
in the liquid film forming process, the substrate rotates at a first speed;
in the developing process, the substrate rotates at a speed lower than the first speed that does not accelerate drying of the liquid film of the developer;
the developing apparatus also performs a cleaning process for washing away the existing developer containing the resist components dissolved therein in the developing process by supplying the developer from the developer supply nozzle to the central portion of the substrate while rotating the substrate at a third speed higher than the second speed; and
the speed of rotation is controlled according to a control signal from the controller.

11. The developing apparatus according to claim 10, wherein the first rotating speed is between 100 rpm and 1,500 rpm, and the second rotating speed is between 10 rpm and 100 rpm.

12. The developing apparatus according to claim 9, wherein the liquid film forming step in which the developer is supplied to the central portion of the substrate from the developer supply nozzle, and the developing step in which the supply of the developer is stopped, are alternatively repeated for a plurality of times in accordance with a control signal from the controller.

13. The developing apparatus according to claim 9, further comprising:
a developer supply nozzle moving mechanism for moving the developer supply nozzle such that the developer supply nozzle can move in a direction along the surface of the substrate according to control of the controller;
wherein:
the controller, before the liquid film forming step in which the developer is supplied from the developer supply nozzle to the central portion of the substrate, controls to continuously supply the developer from the developer supply nozzle to the substrate while moving the developer supply nozzle from a circumferential portion of the substrate to the central portion thereof.

14. The developing apparatus according to claim 9, further comprising:
a developer supply nozzle moving mechanism for moving the developer supply nozzle such that the developer supply nozzle can move in a direction along the surface of the substrate according to control of the controller;
wherein:
the controller, after the liquid film forming step in which the developer is supplied from the developer supply nozzle to the central portion of the substrate, controls to alternatively repeat, for a plurality of times, a cleaning process in which the developer is supplied from the developer supply nozzle to the substrate while moving the developer supply nozzle from the central portion of the substrate to a circumferential portion thereof, and the developing process in which the supply of the developer from the developer supply nozzle to the substrate is stopped.

15. The developing apparatus according to claim 9, wherein:
a plurality of the developer supply nozzles are provided;
in the liquid film forming process, the developer is supplied from the developer supply nozzles to the central portion of the substrate and portions thereof other than the central portion; and
in the developing process, the supply of the developer from the developer supply nozzles to the substrate is stopped.

16. The developing apparatus according to claim 9, further comprising:
a rinsing liquid supply nozzle for supplying a rinsing liquid to the substrate; and
a rinsing liquid supply nozzle moving mechanism for moving the rinsing liquid supply nozzle such that the rinsing liquid supply nozzle can move in a direction along the surface of the substrate according to control of the controller;
wherein the controller, after the liquid film forming process and the developing process, controls to perform a process of supplying the rinsing liquid from the rinsing liquid supply nozzle to the substrate while rotating the substrate, and a process for drying the substrate by rotating the substrate after supplying the rinsing liquid from the rinsing liquid supply nozzle to the substrate.
